(19) United States
(12) Patent Application Publication
(10) Pub. No.: US 2014/0115651 A1
(43) Pub. Date: Apr. 24, 2014

(54) METHOD FOR PROVIDING SEMANTIC APPLICATION

(71) Applicant: ANYPOINT MEDIA GROUP, Burbank, CA (US)

(72) Inventor: Wonjang Baek, Seongnam-si (KR)

(73) Assignee: ANYPOINT MEDIA GROUP, Burbank, CA (US)

(21) Appl. No.: 14/124,556

(22) PCT Filed: Jun. 8, 2012
(86) PCT No.: PCT/KR2012/004555

§ 371 Date: Dec. 6, 2013

(30) Foreign Application Priority Data
Jun. 10, 2011 (KR) 10-2011-0056264

(51) Int. Cl. H04N 21/43

(52) U.S. Cl. CPC H04N 21/43
USPC 725/131

(57) ABSTRACT

The present invention relates to a method for providing a digital broadcast, and for providing a semantic application from a receiver for executing the semantic application, which is provided independently from the digital broadcast, and comprises the steps of: (a) executing at least one first semantic application based on a first event while providing the digital broadcast; (b) executing at least one second semantic application based on a second event while executing step (a); and (c) managing the state of the at least one first semantic application depending on the property of same while executing step (b). According to the present invention, a plurality of semantic applications can be provided, and the state of each of the plurality of semantic applications can be managed according to the property and execution mode of the semantic applications, even in an environment where the plurality of semantic applications are executed, thereby efficiently using a system resource of the receiver.

### TECHNICAL FIELD

The present invention relates to a method for providing a semantic application; and more particularly, to a semantic application providing method capable of providing a plurality of semantic applications and managing states of the plurality of semantic applications according to their attributes and their execution modes in an environment where the plurality of semantic applications are executed, thereby enabling efficient utilization of system resources of a receiver.

### BACKGROUND ART

Unlike analog broadcasting receivers in the related art, digital broadcasting receivers providing a digital broadcast program may also receive and execute applications transmitted together with the digital broadcast program (video) signal during the digital broadcast program.

In this specification, the term “digital broadcasting receiver” refers to an apparatus capable of receiving a digital program (video) signal via a broadcasting network or a communication network, processing the program signal, and then providing a moving image of the program.

The digital broadcasting receiver includes a receiving unit for receiving and processing the digital broadcast signal and a display unit for displaying the moving image obtained by processing the digital broadcast signal. An example of the receiving unit is a set-top box, and an example of the display unit is a display panel. Alternatively, a digital broadcasting receiver may have a display unit integrated with a receiving unit.

The digital broadcasting receivers in the related art may receive and execute applications transmitted together with program signals via a broadcasting network or a communication network. Hereinafter, the term “in-band application” refers to an application that is transmitted together with a program signal via a broadcasting network or a communication network. In general, an in-band application is repetitively transmitted via a broadcasting network or a communication network in the form of Object Carousel. The size and number of in-band applications should be limited because they are transmitted repetitively in the form of Object Carousel. For terrestrial broadcasting, for example, a program signal and an Object Carousel-type in-band application should be transmitted within a limited transmission bandwidth for a channel, thereby limiting the size and number of the in-band applications. Accordingly, the digital broadcasting receiver in the related art can provide approximately one in-band application for each channel or program. Therefore, it is difficult to provide an application personalized according to individual user preferences because the same in-band application is provided to all users.

### DISCLOSURE

### Technical Problem to be Solved

The present invention provides a method for providing a plurality of semantic applications; and more particularly, to a semantic application providing method capable of managing a state of each of the semantic applications according to the attribute and the execution mode in an environment where two or more semantic applications are to be executed, thereby enabling efficient utilization of system resources of a receiver.

### Technical Solution

According to an aspect of the present invention, there is provided a method of providing a semantic application by a receiver configured to provide a digital broadcast program and execute the semantic application provided independently of the digital broadcast program, the method including: (a) executing at least one first semantic application based on a first event while providing the digital broadcast program; (b) executing at least one second semantic application based on a second event during the step (a); and (c) managing a state of the at least one first semantic application according to an attribute of the at least one first semantic application during the step (b).

Each of the at least one first semantic application and each of the at least one second semantic application may have one of a program-bound attribute, a channel-bound attribute and an unbound attribute.

Each of the first event and the second event may include at least one of: a change of a digital broadcast channel, a change of the digital broadcast program, a termination of the digital broadcast program, a user request and a condition for execution set for the receiver.

The at least one second semantic application may be in a default mode or in a user check mode, and the step (b) may include: (b-1) executing one of the at least one second semantic application in the default mode; (b-2) receiving an execution request for executing one of the at least one second semantic application in the user check mode; and (b-3) executing the one of the at least one second semantic application in the user check mode in response to the execution request.

The at least one second semantic application may be in a default mode or in a user check mode, and one of the at least one second semantic application may be in the default mode and have the channel-bound attribute.

The at least one second semantic application may be in a default mode or in a user check mode, and one of the at least one second semantic application may be in the default mode and have the program-bound attribute.

The at least one second semantic application may be in a default mode or in a user check mode, and one of the at least one second semantic application may be in the default mode and have the unbound attribute.

The at least one second semantic application may be in a default mode or in a user check mode, one of the at least one second semantic application may be in the default mode and have the unbound attribute, and the step (b) may include executing the one of the at least one second semantic application in the default mode having the unbound attribute prior to every other of the at least one second semantic application.

The at least one second semantic application may be in a default mode or in a user check mode, a first one of the at least one second semantic application may be in the default mode and have the program-bound attribute, a second one of the at least one second semantic application may be in the default mode and have the channel-bound attribute, and the step (b) may include executing the first one of the at least one second semantic application prior to the second one of the at least one second semantic application.

The step (c) may include continuously executing one of the at least one first semantic application having the unbound attribute.

The second event may be a change of a digital broadcast channel, and the step (c) may include changing a state of one of the at least one first semantic application having the program-bound attribute or the channel-bound attribute to a paused state.

The step (c) may include changing the state of the one of the at least one first semantic application having the program-bound attribute or the channel-bound attribute from the paused state to a terminated state after a predetermined amount of time elapses.

The second event may be a change of the digital broadcast program or a termination of the digital broadcast program, and the step (c) may include changing a state of one of the at least one first semantic application having the program-bound attribute to a terminated state.

The digital broadcast program may be provided by at least one of: a digital terrestrial broadcasting, a digital cable broadcasting, a digital satellite broadcasting, an over-the-top (OTT) service and an internet protocol television (IPTV) service.

The digital broadcast program may be received via a broadcasting network to be provided by the receiver, and the at least one first semantic application and the at least one second semantic application may be received via a communication network.

### Advantageous Effects

According to the present invention, it is possible to provide a semantic application independently of digital broadcasting. Therefore, an entity other than a digital broadcasting provider, such as a manufacturer or a seller of the receiver, may provide the semantic application. Since the semantic application is provided independently of digital broadcast programs, the number of semantic applications that can be provided at the same time is not as limited as for in-band applications, and thus a greater number of semantic applications can be provided.

According to the present invention, it is possible to manage the state of each semantic application according to the attribute and the execution mode even in an environment where two or more semantic applications are executed. Accordingly, the system resources of the receiver may be used efficiently.

According to the present invention, it is also possible to ensure that the semantic application having an unbound attribute can be executed continuously while the state of each semantic application is managed. Accordingly, the semantic application used for advertisement or information delivery provided by a receiver manufacturer or a digital broadcasting provider can be executed without stopping for a period of time.

According to the present invention, the semantic application can be executed by the receiver irrespectively of the digital broadcasting provider. When there are two or more multiple system operators (MSOs) in a digital cable environment, the receiver may receive the semantic application from an entity such as a manufacturer or a seller of the receiver who supplies the semantic application as well.

According to the present invention, it is also possible for the receiver to provide a semantic application personalized to each user. Therefore, a user can select a semantic application from among two or more semantic applications, and a semantic application suitable for each user can be provided.

### DESCRIPTION OF DRAWINGS

FIG. 1 is a view showing a system environment including a receiver for executing a semantic application providing method according to the present invention.

FIG. 2 is an exemplary flowchart showing the semantic application providing method according to the present invention.

FIG. 3 is an exemplary flowchart showing a sequence of executing at least one second application based on an execution mode in the semantic application providing method according to the present invention.

FIG. 4 is an exemplary flowchart showing a sequence of executing some of the at least one second application prior to every other of the at least one second application in the semantic application providing method according to the present invention.

FIG. 5 is an exemplary flowchart showing a sequence of managing a state of the at least one first semantic application based on an attribute of the at least one first semantic application in the semantic application providing method according to the present invention.

### BEST MODE

Hereinafter, a semantic application providing method of the present invention will be described in detail with reference to the accompanying drawings.

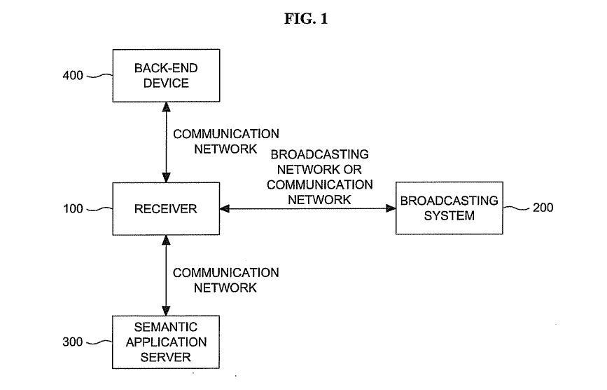

FIG. 1 is a view showing a system environment including a receiver for executing a semantic application providing method according to the present invention.

Referring to FIG. 1, a system environment according to the present invention includes a receiver 100, a broadcasting system 200 and a semantic application server 300. In addition, the system environment may further include a back-end device 400.

The receiver 100 receives a digital broadcast signal from the broadcasting system 200 via a broadcasting network or a communication network, processes the received digital broadcast signal, and causes a moving image to be displayed. The receiver 100 may also receive a semantic application from the semantic application server 300 to thereby execute the received semantic application. Alternatively, the receiver 100 may execute a semantic application stored in the receiver 100.

In this specification, the semantic application refers to an application that is received and executed by the receiver 100 independently of the digital broadcast signal. The semantic application is supplied together with a digital broadcast program. In particular, the semantic application may be supplied in connection with a specific channel or a specific broadcast program. The semantic application may be displayed as an image partially or entirely occupying a screen while the receiver 100 causes a moving image of the digital broadcast program to be displayed on the screen.

The in-band application is transmitted by the broadcasting system 200 together with a digital broadcast signal via a broadcasting or communication network. For terrestrial digital broadcasting, the digital broadcasting receiver in the related art receives a digital broadcast signal and an in-band application through terrestrial transmission. As such, the size and number of in-band applications that can be received and executed by the digital broadcasting receiver are limited.

However, the receiver 100 receives a digital broadcast signal from the broadcasting system 200 via a broadcasting network, and receives a semantic application from the semantic application server 300 through a communication network separate from the broadcasting network. Since the semantic application is provided independently of the digital broadcast signal, the size and number of semantic applications are not as limited as those of in-band applications.

The broadcasting system 200 transmits the digital broadcast signal. For example, a digital terrestrial broadcasting provider, a digital cable broadcasting provider or an IPTV provider operates the broadcasting system 200.

The semantic application server 300 is configured to store a plurality of semantic applications, and is connected to the receiver 100 through a communication channel so that a semantic application may be selected from among the plurality of semantic applications according to a request from the receiver 100. The semantic application server 300 is preferably operated by a digital broadcasting provider or a manufacturer of the receiver 100, but may also be operated by other entities such as a platform provider.

The back-end device 400 provides additional information for executing the semantic application. For example, the back-end device 400 stores and provides extension EPG data, closed-caption (CC) data, and metadata for digital broadcast programs to the receiver 100. For digital broadcasting in the related art, the EPG data, the CC data or the metadata is transmitted together with the digital broadcast signal. However, according to the present invention, the back-end device 400 may store the EPG data, the CC data or the metadata.

Referring to FIG. 1, the semantic application is received not from the broadcasting system 200 but from the semantic application server 300. Accordingly, the system environment of the present invention is different from the digital broadcasting environment in the related art where the in-band applications are provided only by the broadcasting system 200. Further, one or more semantic applications can be provided by the receiver 100 in the system environment of the present invention.

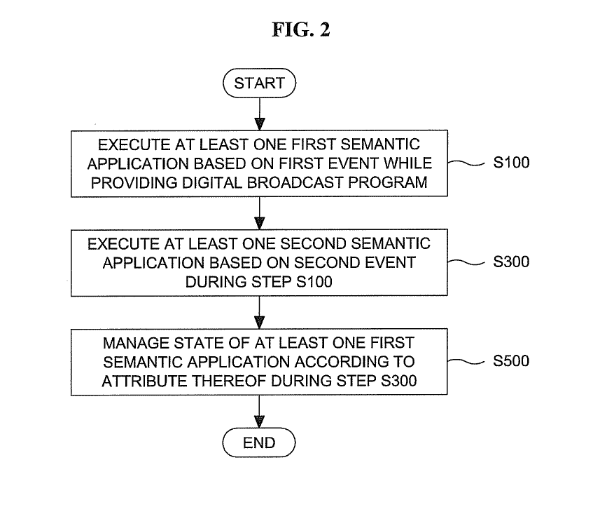

The semantic application providing method according to the present invention will be described below in more detail with reference to FIG. 2.

FIG. 2 is an exemplary flowchart showing a semantic application providing method according to the present invention.

The receiver 100 of the present invention executes at least one first semantic application and at least one second semantic application that are provided independently from digital broadcasting, and provides the digital broadcast program at the same time.

Examples of the digital broadcasting include a digital terrestrial broadcasting, a digital cable broadcasting, a digital satellite broadcasting, an over-the-top (OTT) service and an internet protocol television (IPTV) service.

The digital broadcast program may be transmitted from the broadcasting system 200 to the receiver 100 via the broadcasting network while the at least one first semantic application and the at least one second semantic application are transmitted from the semantic application server 300 via the communication network. Alternatively, the at least one first semantic application and the at least one second semantic application may be stored in the receiver 100.

In step S100, the receiver 100 executes at least one first semantic application based on a first event while providing a digital broadcast program.

Hereinafter, the semantic application refers to the at least one first semantic application and/or at least one second semantic application (which will be described later).

The semantic application may have one of a “channel-bound” attribute, a “program-bound” attribute and an “unbound” attribute.

The channel-bound attribute is an attribute designated to execute the semantic application corresponding to a specific digital broadcast channel. When the receiver 100 receives and provides any program of the specific digital broadcast channel, the semantic application having the channel-bound attribute is executed.

The program-bound attribute is an attribute designated to execute the semantic application corresponding to a specific digital broadcast program. When the receiver 100 receives and provides the specific program, the semantic application having the program-bound attribute is executed.

The unbound attribute is an attribute designated to execute the semantic application regardless of the digital broadcast channel or program. The semantic application having the unbound attribute is executed while power is supplied to operate the receiver 100.

Each of the first event and a second event (which will be described later) may include at least one of the following: a change of the digital broadcast channel, a change of the digital broadcast program, a termination of the digital broadcast program, a user request and a condition for execution set for the receiver 100.

When power is supplied to the receiver 100, the first event (which is the condition for execution set for the receiver 100) occurs. Then, the first semantic application having the unbound attribute is executed according to the first event.

When the digital broadcast channel is changed, the first event (which is the change of the digital broadcast channel) occurs. When the digital broadcast channel is changed, the digital broadcast program is also changed. Then, the first semantic application having the channel-bound attribute or the program-bound attribute is executed according to the first event.

When a previous program is terminated and a new program begins while the digital broadcast channel remains unchanged, the first event (which is the change of the digital broadcast program) occurs. Then, the first semantic application having the program-bound attribute is executed according to the first event.

When a request for executing one of at least one first semantic application is inputted by the user while the digital broadcast program is being received, the first event (which is the user request) occurs. Then, the first semantic application corresponding to the user request is executed according to the first event.

In step S300, the receiver 100 executes at least one second semantic application based on a second event while step S100 is performed.

The second event may include at least one of the following: a change of the digital broadcast channel, a change of the digital broadcast program, a termination of the digital broadcast program, a user request and a condition for execution set for the receiver 100.

The at least one second semantic application may be in a “default” mode or in a “user check” mode.

The default mode is an execution mode where the semantic application is executed automatically without requiring a user's confirmation.

The user check mode is an execution mode where the semantic application is executed only when the user's confirmation is received.

A provider of a semantic application may set the execution mode of the semantic application. Alternatively, the execution mode of a semantic application may be set by an application developer, a digital broadcasting provider, a digital broadcasting contents provider, a provider of the receiver 100 or a seller of the receiver 100. Alternatively, the execution mode may be set by a user of the receiver 100. Alternatively, the execution mode of the semantic application may be controlled by the receiver 100.

A second semantic application which is in the default mode and has the channel-bound attribute corresponding to a specific digital broadcast channel is automatically executed according to, for example, the change of the digital broadcast channel occurring when the receiver 100 provides a program of the specific digital broadcast channel.

A second semantic application which is in the user check mode and has the program-bound attribute corresponding to a specific digital broadcast program is executed not automatically but in response to the user's confirmation according to, for example, the change of the digital broadcast channel occurring when the receiver 100 provides the specific digital broadcast program (not depending on the digital broadcast channel).

In step S300, the at least one second application may be executed automatically or in response to the user's confirmation depending on the execution mode.

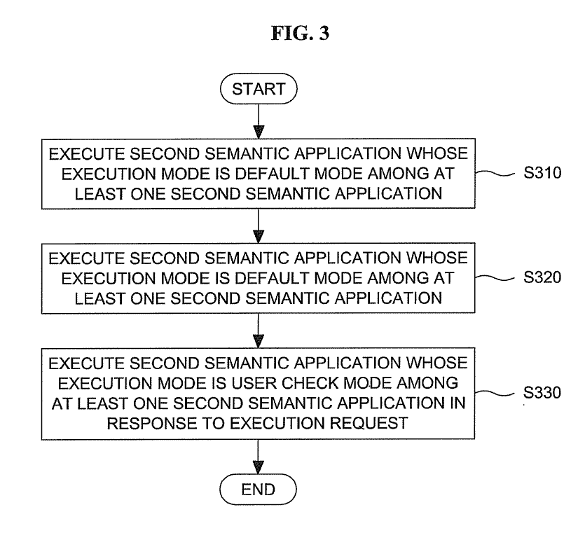

FIG. 3 is an exemplary flowchart showing a sequence of executing at least one second application based on an execution mode in the semantic application providing method according to the present invention.

In step S310, the receiver 100 executes a second semantic application whose execution mode is set to be the default mode among the at least one second semantic application.

In step S320, the receiver 100 receives an execution request for executing a second semantic application whose execution mode is set to be the user check mode among the at least one second semantic application.

In step S330, the receiver 100 executes the second semantic application whose execution mode is set to be the user check mode according to the execution request received in step S320.

One of the at least one second semantic application may be in the default mode and have the channel-bound attribute.

If a second semantic application is in the default mode and has the channel-bound attribute corresponding to a specific digital broadcast channel, the second semantic application is automatically executed when the specific digital broadcast channel is selected.

One of the at least one second semantic application may be in the default mode and have the program-bound attribute.

If a second semantic application is in the default mode and has the program-bound attribute corresponding to a specific digital broadcast program, the second semantic application is automatically executed when the specific program is provided by the receiver 100.

One of the at least one second semantic application may be in the default mode and have the unbound attribute.

If the second semantic application is in the default mode and has the unbound attribute, the second semantic application is automatically executed when power is supplied to the receiver 100.

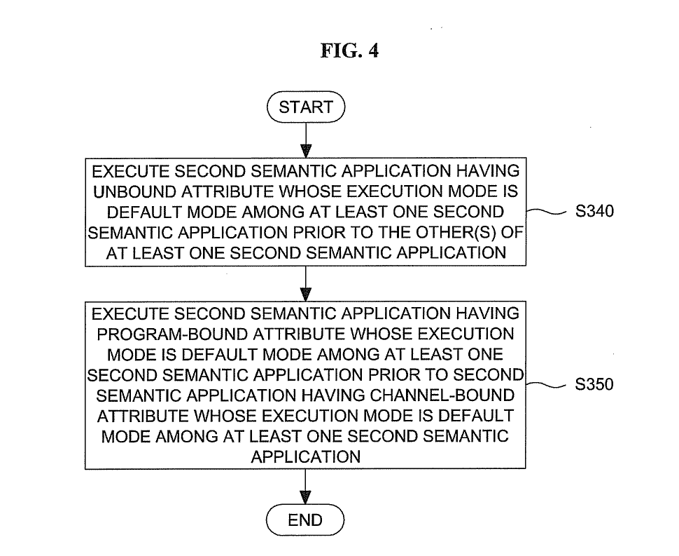

FIG. 4 is an exemplary flowchart showing a sequence of executing some of the at least one second application prior to the other(s) of the at least one second application in the semantic application providing method according to the present invention.

In step S340, the receiver 100 may execute a second semantic application which is in the default mode and has the unbound attribute among the at least one second semantic application prior to every other of the at least one second semantic application.

The second semantic application having the unbound attribute whose execution mode is set to be the default mode may be used for advertisement or information delivery by a manufacturer of the receiver 100 or a digital broadcasting provider. Accordingly, the second semantic application which is in the default mode and has the unbound attribute may need to be executed prior to the other(s) of the at least one second semantic application.

When two or more semantic applications cannot be executed at the same time due to the limited system resources of the receiver 100, the receiver 100 executes the second semantic application having the unbound attribute whose execution mode is set to be the default mode among the at least one second semantic application.

If there are the second semantic application in the default mode having the program-bound attribute and the second semantic application in the default mode having the channel-bound attribute among the at least one second semantic application, the receiver 100 may execute the second semantic application in the default mode having the program-bound attribute prior to the second semantic application in the default mode having the channel-bound attribute in step S350.

When the change of the digital broadcast channel occurs as the second event, the receiver 100 may have to provide some of the at least one second semantic application in step S300. In this case, the receiver 100 may have to execute a second semantic application in the default mode having the unbound attribute, a second semantic application in the default mode having the program-bound attribute and a second semantic application in the default mode having the channel-bound attribute.

However, if all of them cannot be executed at the same time due to the limited system resources of the receiver 100, the receiver 100 may first execute the second semantic application in the default mode having the unbound attribute, then the second semantic application in the default mode having the program-bound attribute, and then the second semantic application in the default mode having the channel-bound attribute.

In step S500, the receiver 100 manages the state of each of the at least one first semantic application based on the attribute of each of the at least one first semantic application while step S300 is performed.

That is, the receiver 100 manages the state of one of the at least one first semantic application that is no longer executed while at least one second application is executed according to the second event.

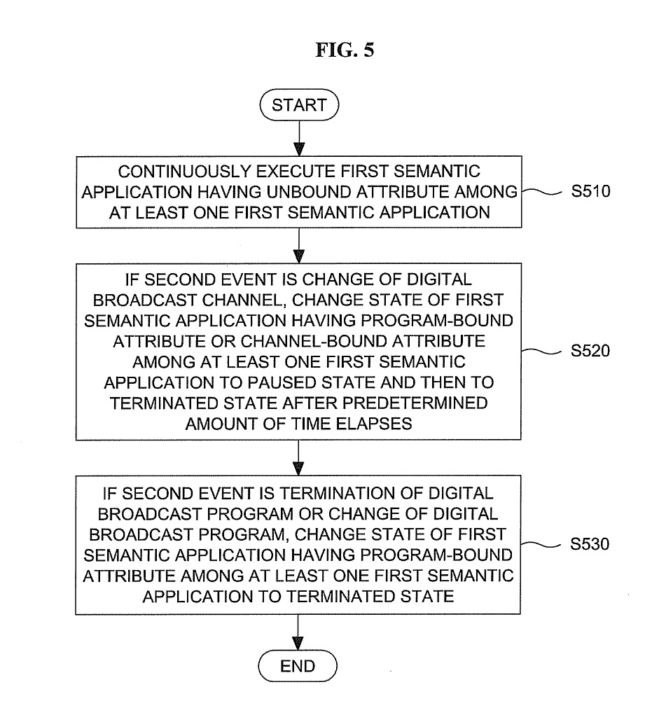

FIG. 5 is an exemplary flowchart showing a sequence of managing a state of the at least one first semantic application based on an attribute of the at least one first semantic application in the semantic application providing method according to the present invention.

In step S510, the receiver 100 continues to execute a first semantic application having the unbound attribute among the at least one first semantic application.

As described above, the first semantic application in the default mode having the unbound attribute among the at least one first semantic application may be used for advertisement or information delivery by a manufacturer of the receiver 100 or a digital broadcasting provider. Accordingly, the second semantic application in the default mode having the unbound attribute may need to be executed without stopping even when the second event occurs.

In step S520, when the change of the digital broadcast channel occurs as the second event, the receiver 100 changes the state of the first semantic application having the program-bound attribute or channel-bound attribute to a paused state.

When the channel is changed to another channel, the first semantic application having the program-bound attribute or channel-bound attribute corresponding to the previous channel no longer needs to be executed. Therefore, the state is temporarily changed to a paused state for preparing for the possibility that the channel will return to the previous channel. After a predetermined amount of time elapses, the state of the first semantic application is changed from the paused state to a terminated state. This can allow the system resources of the receiver 100 to be efficiently used.

In step S530, when the termination or the change of the digital broadcast program occurs as the second event, the receiver 100 changes a state of the first semantic application having the program-bound attribute to a terminated state.

The first semantic application having the program-bound attribute no longer needs to be executed because the program corresponding thereto has already been terminated or changed to another program. Therefore, its state is changed to a terminated state. This can allow the system resources of the receiver 100 to be efficiently used.

Although the embodiment of the present invention has been described in detail for purposes of illustration, it should be understood that numerous other modifications can be devised by those skilled in the art that will fall within the scope of the principles of the present invention.

Therefore, the embodiments of the present invention are to be considered descriptive and not restrictive of the present invention, and do not limit the spirit and scope of the present invention. The scope of the present invention should be determined by the following claims and their appropriate legal equivalents.

### INDUSTRIAL APPLICABILITY

According to the present invention, it is possible to provide a semantic application independently of digital broadcasting. Therefore, an entity other than a digital broadcasting provider, such as a manufacturer or a seller of the receiver, may provide the semantic application. Since the semantic application is provided independently of digital broadcast programs, the number of semantic applications that can be provided at the same time is not as limited as for in-band applications, and thus a greater number of semantic applications can be provided.

According to the present invention, it is possible to manage the state of each semantic application according to the attribute and the execution mode even in an environment where two or more semantic applications are executed. Accordingly, the system resources of the receiver may be used efficiently.

According to the present invention, it is also possible to ensure that the semantic application having an unbound attribute can be executed continuously while the state of each semantic application is managed. Accordingly, the semantic application used for advertisement or information delivery provided by a receiver manufacturer or a digital broadcasting provider can be executed without stopping for a period of time.

According to the present invention, the semantic application can be executed by the receiver irrespectively of the digital broadcasting provider. When there are two or more multiple system operators (MSOs) in a digital cable environment, the receiver may receive the semantic application from an entity such as a manufacturer or a seller of the receiver who supplies the semantic application as well.

According to the present invention, it is also possible for the receiver to provide a semantic application personalized to each user. Therefore, a user can select a semantic application from among two or more semantic applications, and a semantic application suitable for each user can be provided.

1. A method of providing a semantic application by a receiver configured to provide a digital broadcast program and execute the semantic application provided independently of the digital broadcast program, the method comprising:
(a) executing at least one first semantic application based on a first event while providing the digital broadcast program;
(b) executing at least one second semantic application based on a second event during the step (a); and
(c) managing a state of the at least one first semantic application according to an attribute of the at least one first semantic application during the step (b).

2. The method of claim 1, wherein each of the at least one first semantic application and each of the at least one second semantic application have one of a program-bound attribute, a channel-bound attribute and an unbound attribute.

3. The method of claim 1, wherein each of the first event and the second event includes at least one of: a change of a digital broadcast channel, a change of the digital broadcast program, a termination of the digital broadcast program, a user request and a condition for execution set for the receiver.

4. The method of claim 1, wherein the at least one second semantic application is in a default mode or in a user check mode, and
the step (b) comprises:
(b-1) executing one of the at least one second semantic application in the default mode;
(b-2) receiving an execution request for executing one of the at least one second semantic application in the user check mode; and
(b-3) executing the one of the at least one second semantic application in the user check mode in response to the execution request.

5. The method of claim 2, wherein the at least one second semantic application is in a default mode or in a user check mode, and
one of the at least one second semantic application is in the default mode and has the channel-bound attribute.

6. The method of claim 2, wherein the at least one second semantic application is in a default mode or in a user check mode, and
one of the at least one second semantic application is in the default mode and has the program-bound attribute.

7. The method of claim 2, wherein the at least one second semantic application is in a default mode or in a user check mode, and
one of the at least one second semantic application is in the default mode and has the unbound attribute.

8. The method of claim 2, wherein the at least one second semantic application is in a default mode or in a user check mode,
one of the at least one second semantic application is in the default mode and has the unbound attribute, and
the step (b) comprises executing the one of the at least one second semantic application in the default mode having the unbound attribute prior to every other of the at least one second semantic application.

9. The method of claim 2, wherein the at least one second semantic application is in a default mode or in a user check mode,
a first one of the at least one second semantic application is in the default mode and has the program-bound attribute,
a second one of the at least one second semantic application is in the default mode and has the channel-bound attribute, and
the step (b) comprises executing the first one of the at least one second semantic application prior to the second one of the at least one second semantic application.

10. The method of claim 2, wherein the step (c) comprises continuously executing one of the at least one first semantic application having the unbound attribute.

11. The method of claim 2, wherein the second event is a change of a digital broadcast channel, and
the step (c) comprises changing a state of one of the at least one first semantic application having the program-bound attribute or the channel-bound attribute to a paused state.

12. The method of claim 11, wherein the step (c) comprises changing the state of the one of the at least one first semantic application having the program-bound attribute or the channel-bound attribute from the paused state to a terminated state after a predetermined amount of time elapses.

13. The method of claim 2, wherein the second event is a change of the digital broadcast program or a termination of the digital broadcast program, and
the step (c) comprises changing a state of one of the at least one first semantic application having the program-bound attribute to a terminated state.

14. The method of claim 1, wherein the digital broadcast program is provided by at least one of: a digital terrestrial broadcasting, a digital cable broadcasting, a digital satellite broadcasting, an over-the-top (OTT) service and an internet protocol television (IPTV) service.

15. The method of claim 1, wherein the digital broadcast program is received via a broadcasting network to be provided by the receiver, and the at least one first semantic application and the at least one second semantic application are received via a communication network.
